(19) United States
(12) Patent Application Publication
(10) Pub. No.: US 2006/0274084 A1
(43) Pub. Date: Dec. 7, 2006

(54) Table data entry using instrument markers

(76) Inventors: Chenjing Fernando, Bothell, WA (US); Corydon J. Boyan, Santa Rosa, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/145,614

(22) Filed: Jun. 6, 2005

(51) Int. Cl. G09G 5/00

(52) U.S. Cl. 345/619

(57) ABSTRACT

An instrument uses a marker as a passive element for indicating measurement and reference points and also uses the marker to enter data. In response to a user placing the marker on a graph and selecting a predetermined key on a keypad of the instrument, the instrument enters at least one value represented by the marker into an active table.

### BACKGROUND

In conventional spectrum analyzers, data for tables such as for limit line tables, line tables and correction tables are entered manually, point-by-point into a displayed onscreen table. Typically a user enters each point on the table, for example by typing a frequency and amplitude value for each entry. The procedure is tedious and error prone.

Markers are used in spectrum analyzers as passive elements, either as position indicators of measurement data or reference pointers for advanced calculations.

### SUMMARY OF THE INVENTION

In accordance with an embodiment of the present invention, an instrument uses a marker as a passive element for indicating measurement and reference points and also uses the marker to enter data. In response to a user placing the marker on a graph and selecting a predetermined key on a keypad of the instrument, the instrument enters values represented by the marker into an active table.

### BRIEF DESCRIPTION OF THE DRAWINGS

FIG. 1 shows a simplified front view of an electronic instrument.

FIG. 2, FIG. 3, FIG. 4, FIG. 5, FIG. 6, FIG. 7, FIG. 8 and FIG. 9 illustrate entry of data points into a table in accordance with an embodiment of the present invention.

### DESCRIPTION OF THE EMBODIMENT

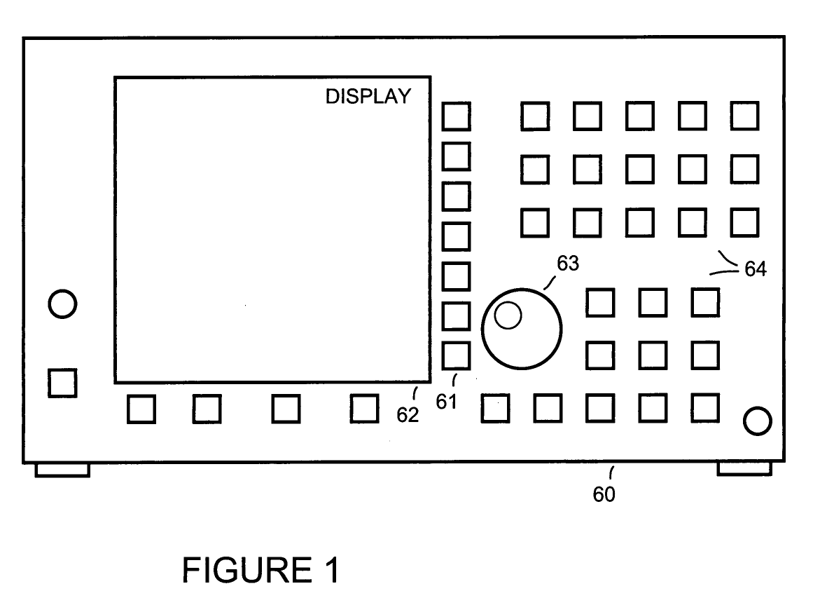

FIG. 1 shows a simplified view of an instrument 60. For example instrument 60 is a spectrum analyzer. Instrument 60 includes a display 62 and a keypad composed of various keys 64 used to receive input from a user. The keypad also includes a column 61 of keys that correspond to soft keys shown on display 62. Instrument 60 also includes an adjustment knob 63.

As further illustrated below, instrument 60, in addition to using a marker as a passive element for indicating measurement and reference points, also uses a marker to enter data into a table. For example, the table is a limit line table, a line table or a correction table.

For example, in response to a user placing a marker on a graph and selecting one of keys 61 or keys 64, instrument 60 enters one or more values represented by the marker into an active table. When instrument 60 is in a fixed mode, the values include, for example, a frequency and amplitude position pair or a time and amplitude position pair. When instrument 60 is in a normal mode, the values include, for example, a frequency or time value based on position of the marker and a corresponding amplitude value of a displayed trace. Alternatively, the values can include a delta value based on relative position of the marker to a trace on the graph.

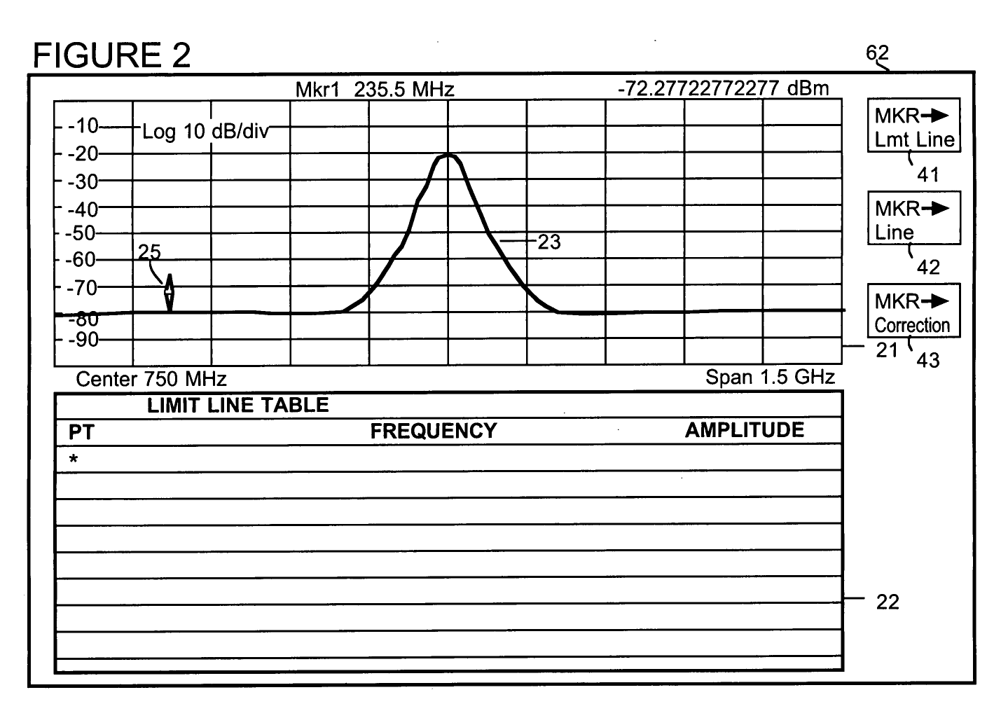

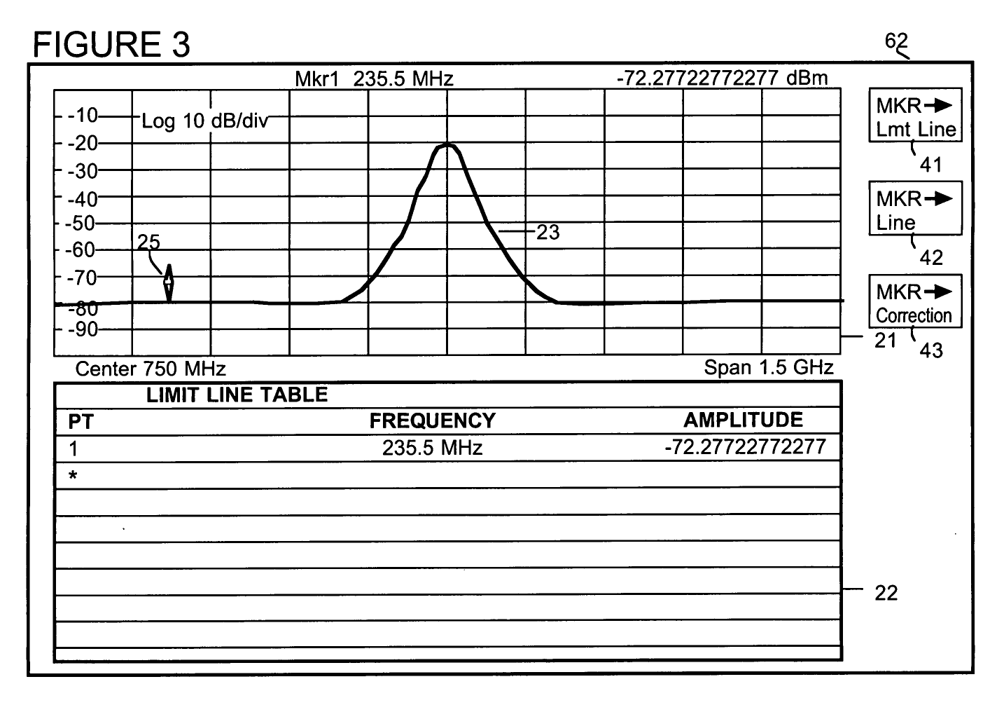

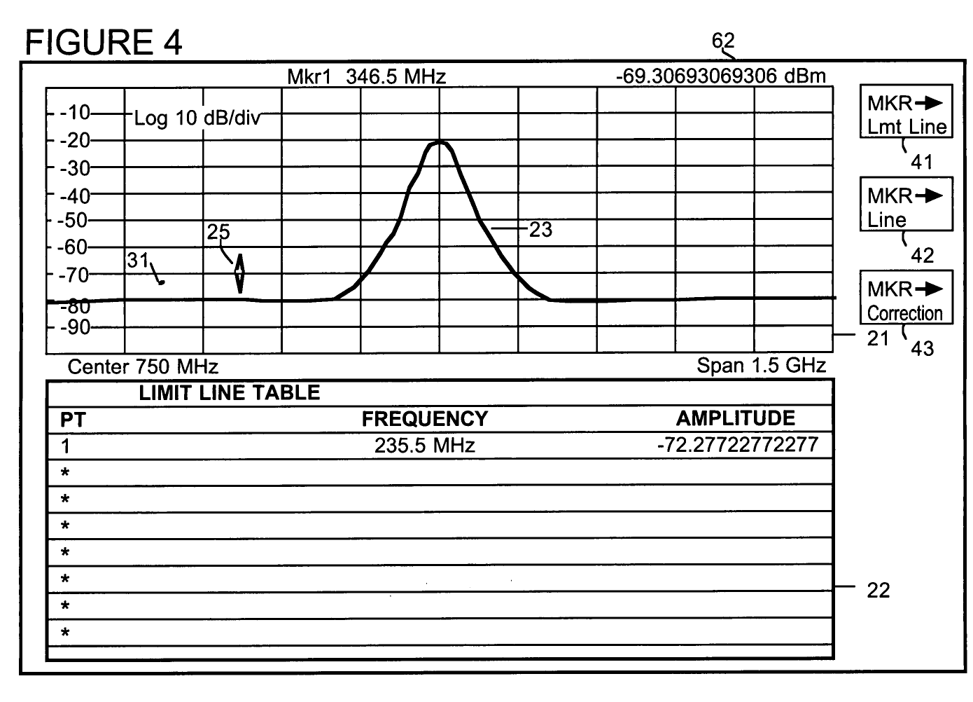

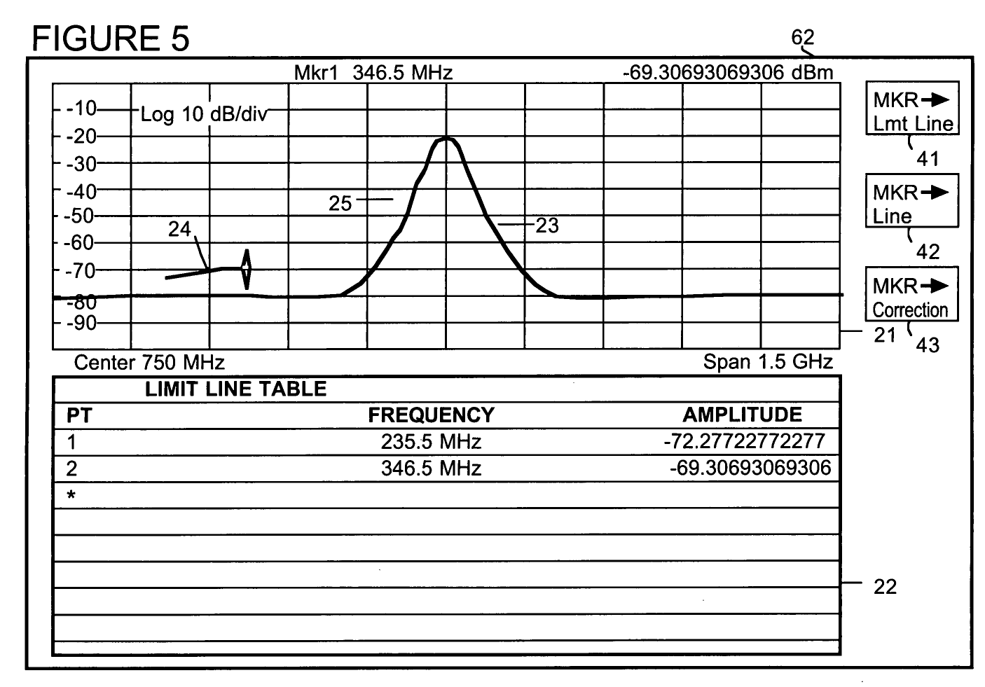

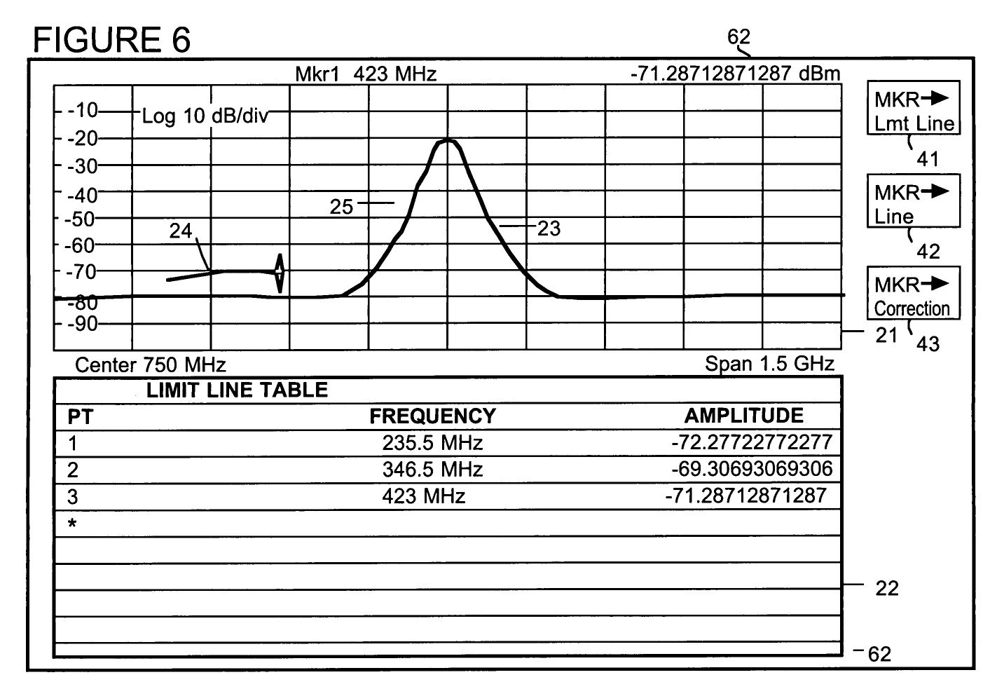

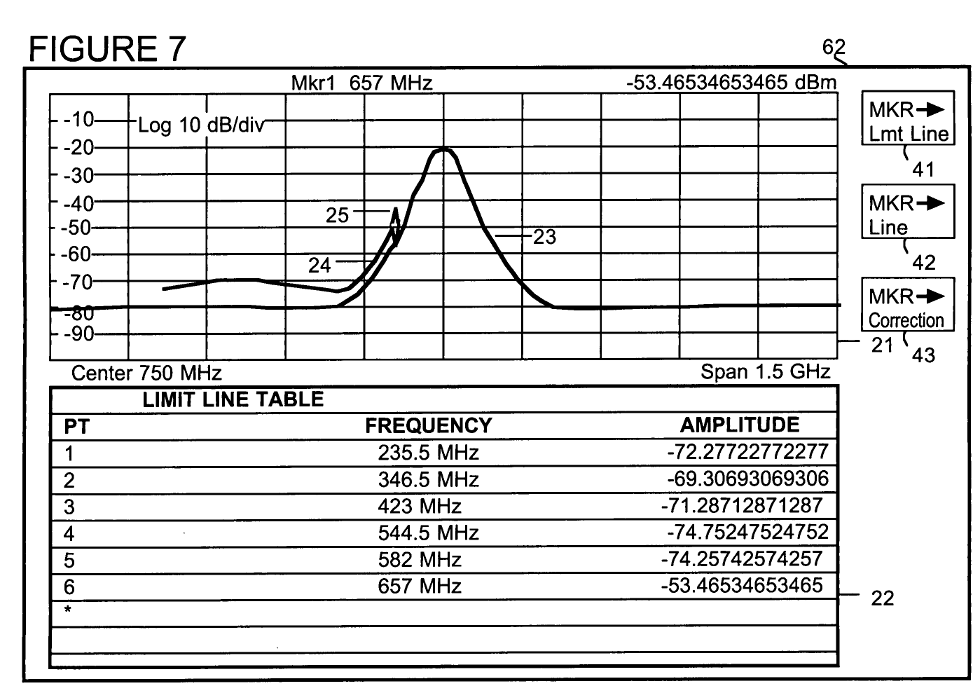

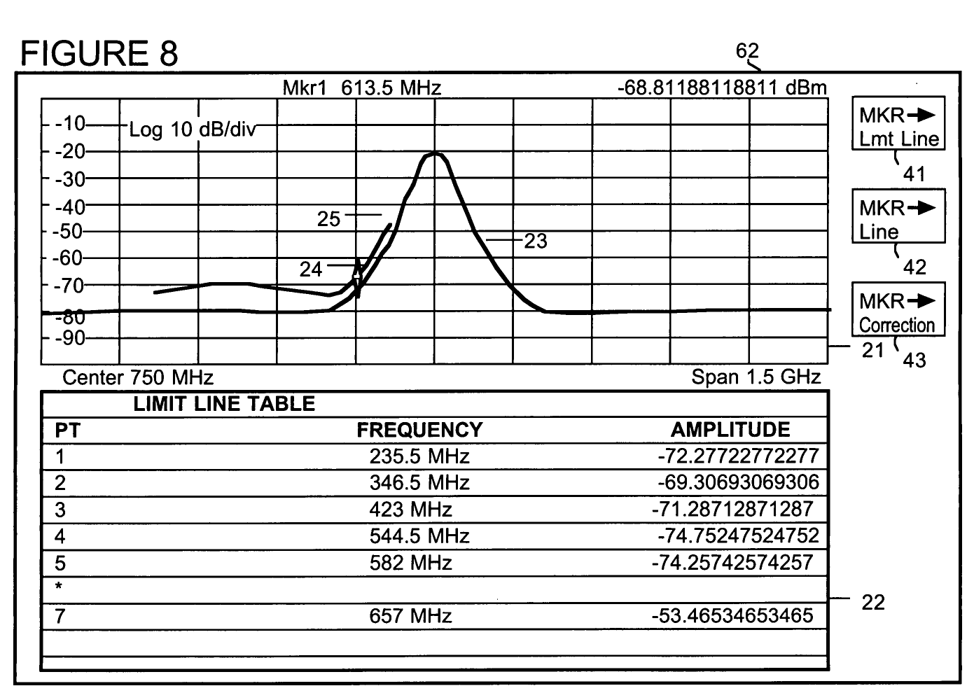

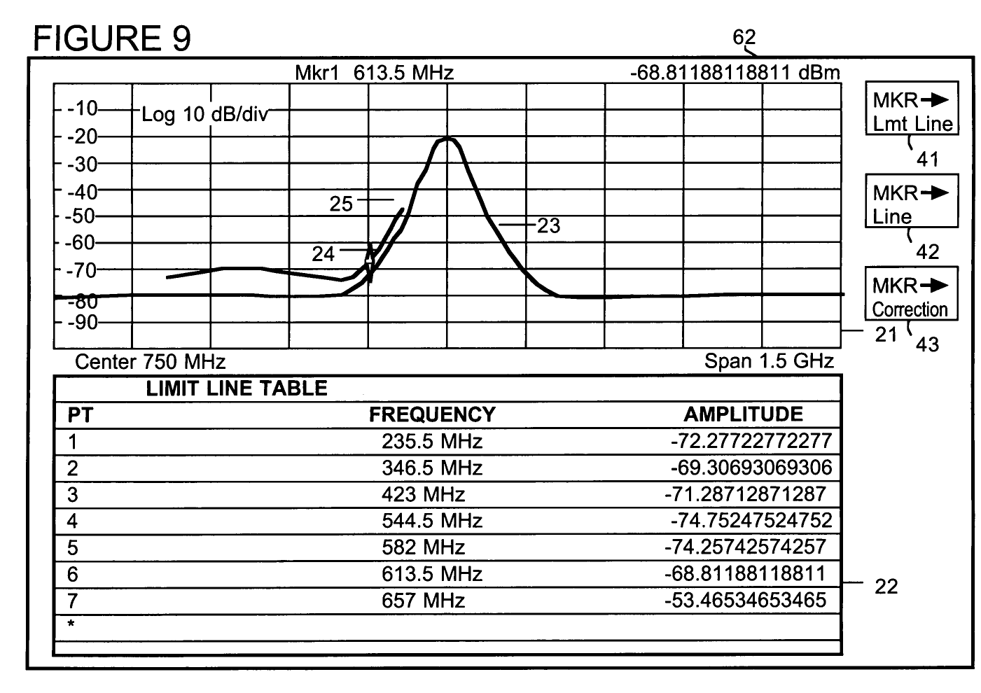

For example, FIG. 2 shows a simplified sample screen visible on display 62. On a top half of the screen shown on display 62, a graph 21 includes a trace 23 and a marker 25. At the top of graph 21, a frequency value and amplitude value (in Decibels referred to one milliwatt (dBm)) are listed as current values for the current position of marker 25 on graph 21.

On a bottom half of the screen shown on display 62, a limit line table 22 is shown. The “*” in limit line table 22 indicates the current entry position in limit line table 22.

Current values represented by the current position of marker 25 can be added to a limit line table 22, by a user selecting a soft key from column 61 of keys (shown in FIG. 1) corresponding to a soft key label 41, shown in FIG. 2. Soft key label 42 can be used when adding values represented by marker 25 position to a line table. Soft key label 43 can be used when adding values corresponding to marker position to a correction table.

FIG. 3 shows the result of a user having selected the soft key from column 61 of keys (shown in FIG. 1) corresponding to soft key label 41, shown in FIG. 3. The frequency value and amplitude value that is listed at the top of graph 21 for the current position of marker 25 on graph 21 have been entered into the first line of limit line table 22. The “*” in limit line table 22 indicating the current entry position in limit line table 22 has moved down to mark the new current entry position.

FIG. 4 shows the result of a user having moved marker 25. For example, a user moves marker 25 using knob 63 shown in FIG. 1. As shown in FIG. 3, when marker 25 is moved, the frequency value and the amplitude value listed as current values for the current position of marker 25 on graph 21 are changed to reflect the new position of marker 25. A point 31 shown on graph 21 represents the limit line (currently a limit point) as defined by the current entry in limit line table 22.

FIG. 5 shows the result of a user having selected the soft key from column 61 of keys (shown in FIG. 1) corresponding to soft key label 41, shown in FIG. 5. The frequency value and amplitude value that is listed at the top of graph 21 for the current position of marker 25 on graph 21 have been entered into the second line of limit line table 22. The “*” in limit line table 22 indicating the current entry position in limit line table 22 has moved down to mark the new current entry position. A line 24 shown on graph 21 represents the limit line as defined by the current entries in limit line table 22.

FIG. 6 shows the result of a user having moved marker 25 and having selected the soft key from column 61 of keys (shown in FIG. 1) corresponding to soft key label 41, shown in FIG. 6. As shown in FIG. 6, when marker 25 was moved, the frequency value and the amplitude value listed as current values for the current position of marker 25 on graph 21 were changed to reflect the new position of marker 25. When the user selected the soft key, the frequency value and amplitude value listed at the top of graph 21 for the current position of marker 25 on graph 21 were entered into the third line of limit line table 22. The “*” in limit line table 22 indicating the current entry position in limit line table 22 has moved down to mark the new current entry position. Line 24 shown on graph 21 represents the limit line as defined by the current entries in limit line table 22.

FIG. 7 shows the result of a user having moved marker 25 and having selected the soft key from column 61 of keys (shown in FIG. 1) corresponding to soft key label 41 to enter three more entries into limit line table 22. Each time marker 25 was moved, the frequency value and the decibels (dBm) value listed as current values for the current position of marker 25 on graph 21 were changed to reflect the new position of marker 25. The frequency value and amplitude value that was listed at the top of graph 21 for the current position of marker 25 on graph 21 were entered into the current entry line of limit line table 22 when the soft key from column 61 of keys (shown in FIG. 1) corresponding to soft key label 41 was selected by the user. The “*” in limit line table 22 indicating the current entry position in limit line table 22 moved down to mark each new current entry position. Line 24 shown on graph 21 represents the limit line as defined by the current entries in limit line table 22.

In FIG. 8, the “*” in limit line table 22 indicating the current entry position in limit line table 22 has been moved up in limit line table 22. For example, this was done by a user utilizing directional keys from among keys 64 of instrument 60 (shown in FIG. 1). FIG. 8 also shows the result of a user having moved marker 25. As shown in FIG. 8, when marker 25 is moved, the frequency value and the amplitude value listed as current values for the current position of marker 25 above graph 21 are changed to reflect the new position of marker 25.

FIG. 9 shows the result of a user having selected the soft key from column 61 of keys (shown in FIG. 1) corresponding to soft key label 41, shown in FIG. 5. The frequency value and amplitude value that is listed at the top of graph 21 for the current position of marker 25 on graph 21, have been entered into the formerly indicated current entry position. The “*” in limit line table 22 indicating the current entry position in limit line table 22 has moved down to the bottom of limit line table 22 to mark the new current entry position. Line 24 shown on graph 21 represents the limit line as defined by the current entries in limit line table 22.

The foregoing discussion discloses and describes merely exemplary methods and embodiments of the present invention. As will be understood by those familiar with the art, the invention may be embodied in other specific forms without departing from the spirit or essential characteristics thereof.

For example, the entry of data points when instrument 60 is in fixed mode has been used as an illustration. In fixed mode, both a frequency value (or time value) and amplitude are entered in upon a user selecting a soft key. In normal mode, however, the marker is used only to indicate the frequency (or time) value and the amplitude is calculated based on the amplitude of the signal represented by trace 23 at that frequency (or time) value. Alternatively, in marker delta mode, a delta value based on the difference between the marker and a trace on the graph are entered. Also, while entries have been shown to be selected using soft keys, selections using keys that are not soft keys can also be used.

Accordingly, the disclosure of the present invention is intended to be illustrative, but not limiting, of the scope of the invention, which is set forth in the following claims.

We Claim:

1. In an instrument that uses a marker as a passive element for indicating measurement and reference points, a method for using the marker to enter data, the method comprising:
in response to a user placing a marker on a graph and selecting a predetermined key on a keypad of the instrument, performing the following by the instrument:
entering at least one value represented by the marker into an active table.

2. A method as in claim 1 wherein the instrument is a spectrum analyzer.

3. A method as in claim 1 wherein the at least one value includes a frequency and amplitude position pair.

4. A method as in claim 1 wherein the at least one value includes a time and amplitude position pair.

5. A method as in claim 1 wherein the at least one value includes an amplitude value.

6. A method as in claim 1 wherein the at least one value includes a delta value based on relative position of the marker to a trace on the graph.

7. A method as in claim 1 wherein the at least one value includes a delta value pair based on relative position of the marker to a trace on the graph.

8. A method as in claim 1 wherein the table is a limit line table.

9. A method as in claim 1 wherein the table is a line table.

10. A method as in claim 1 wherein the table is a correction table.

11. A method as in claim 1 wherein the predetermined key is a soft key.

12. An instrument comprising:
a display;
a keypad input; and,
a knob used for controlling location on the display of a marker, the marker being used as a passive element for indicating measurement and reference points;
wherein in response to a user locating the marker on a graph shown on the display and selecting a predetermined key on the keypad input, the instrument enters at least one value represented by the marker into an active table.

13. An instrument as in claim 12 wherein the instrument is a spectrum analyzer.

14. An instrument as in claim 12 wherein the at least one value includes a frequency and amplitude position pair.

15. An instrument as in claim 12 wherein the at least one value includes a time and amplitude position pair.

16. An instrument as in claim 12 wherein the at least one value includes an amplitude value.

17. An instrument as in claim 12 wherein the at least one value includes a delta position pair based on relative position of the marker to a trace on the graph.

18. An instrument as in claim 12 wherein the at least one value includes a delta value based on relative position of the marker to a trace on the graph.

19. An instrument as in claim 12 wherein the table is one of the following:
a limit line table;
a line table;
a correction table.

20. An instrument as in claim 12 wherein the predetermined key is a soft key.
